(19) United States
(12) Patent Application Publication
(10) Pub. No.: US 2015/0135446 A1
(43) Pub. Date: May 21, 2015

(54) WASHING MACHINE

(71) Applicant: LG ELECTRONICS INC., Seoul (KR)

(72) Inventors: Minji KIM, Seoul (KR); Sungmin YE, Seoul (KR); Jeongyun KIM, Seoul (KR)

(21) Appl. No.: 14/541,894

(22) Filed: Nov. 14, 2014

(30) Foreign Application Priority Data
Nov. 15, 2013 (KR) 10-2013-0139206

(51) Int. Cl. D06F 39/08; B05B 9/00; B05B 15/00; C11D 1/83; C11D 11/00

(52) U.S. Cl. CPC D06F 39/083; C11D 1/83; C11D 11/0017; B05B 15/008; B05B 9/002
USPC 8/137; 510/351; 239/136

(57) ABSTRACT

A method for treating laundry spraying a liquid with dissolved detergent into a drum holding laundry, delaying for a predetermined time period after spraying the liquid to allow the detergent to be absorbed in the laundry, spraying steam into the drum to rinse the laundry, and supplying heated air into the drum to dry the laundry. The detergent including 5 to 10 wt % of polyoxyethylene alkylether, 3 to 10 wt % of sodium ethylhexyl sulfate, and the balance of water.

### CROSS-REFERENCE TO RELATED APPLICATION

This application claims priority under 35 U.S.C. §119 to Korean Application No. 10-2013-0139206, filed Nov. 15, 2013, the subject matter of which is hereby incorporated by reference as if fully set forth herein.

### BACKGROUND

1. Field

The present disclosure relates to a detergent applied to laundry by spraying and a method for treating laundry.

2. Related Art

In the technological space of laundry treating apparatus, there are, generally, washing machines, dryers, and combination washing and drying machines.

The washing machine is a machine which performs a process of washing, rinsing, and dehydrating and so on for removing dirt from laundry, such as clothes and beddings, by using water, detergent, and mechanical action. There are top loading types in which a drum having the laundry filled therein is rotated round a vertical shaft, and front loading types in which the drum having the laundry filled therein is rotated round a horizontal shaft.

The dryer is a machine for applying heated air to a drying object for drying the same, by introducing the drying object to a rotatable drum and applying heated or cold air thereto for drying the laundry.

The combination washing and drying machine, having functions of both washing and drying, is a machine for introducing the laundry, such as clothes and the like, to the rotatable drum, selecting a desired function and performing washing or drying.

The laundry treating apparatus may have a steam supply unit provided thereto for supplying steam to an inside of the drum.

The laundry treating apparatus has a problem in that, though the dirt is generally removed from the laundry locally with the steam supply unit, the local dirt cannot be completely removed from the laundry perfectly by using the steam, only.

### SUMMARY

An object of the present invention is to provide a detergent applied to laundry by spraying, which simply removes a local stain from laundry, and may optionally provide a fiber softening function and a deodorant function.

Another object of the present invention is to provide a method for treating laundry for removing dirt from laundry by using steam and detergent applied to laundry by spraying, the method optionally includes a fiber softening function and a deodorant function. The method can remove a local stain from the laundry.

Objects of the present invention are not limited to above objects, but other objects of the present invention not described yet will be understood to persons skilled in this field of art from the following description.

To achieve the objects of the present invention, a method for treating laundry includes spraying a liquid comprising dissolved detergent into a drum holding laundry, delaying for a predetermined time period after spraying the liquid, to allow the detergent to be absorbed in the laundry, spraying steam into the drum to rinse the laundry, and supplying heated air into the drum to dry the laundry, wherein the detergent comprises 5 to 10 wt % of polyoxyethylene alkylether, 3 to 10 wt % of sodium ethylhexyl sulfate, and the balance of water.

And, in another aspect of the present invention, a detergent including 5 to 10 wt % of polyoxyethylene alkylether, 3 to 5 wt % of sodium ethylhexyl sulfate, and the balance of water.

The detergent for spraying and the method for treating laundry with the same of the present invention have one or more of the following advantages.

First, the local stain stuck to the laundry is more simply removed.

Second, the local stain stuck to the laundry can be removed as well as fiber softening performance and deodorant performance can be provided.

Third, the use of a detergent for spraying having washability, fiber softening performance, and deodorant performance reduces a time period required for treating the laundry.

Fourth, an adequate washing performance can be secured both on water soluble and fat-dissolved contamination sources.

Advantages of the present invention are not limited to above effects, but other effects not described yet will be understood to persons skilled in this field of art from recitations of the claims.

### BRIEF DESCRIPTION OF THE DRAWINGS

Embodiments will be described in detail with reference to the following drawings in which like reference numerals refer to like elements, and wherein:

FIG. 1 is a perspective view illustrating a drying machine according to an embodiment of the present invention;

FIG. 2 is a cross-sectional view taken along line A-A of FIG. 1;

FIG. 3 is an exploded perspective view illustrating a drying machine according to an embodiment of the present invention;

FIG. 4 is a perspective view illustrating the inside of a drying machine including a spray apparatus;

FIG. 5A is a perspective view of a spray apparatus;

FIG. 5B is a view illustrating a flow passage forming unit of a spray apparatus;

FIG. 5C is a cross-sectional view taken along line B-B of FIG. 5B;

FIG. 6 is a view illustrating a coupling structure of a spray apparatus;

FIG. 7 is a graph illustrating a spray pressure according to a spray diameter of a nozzle;

FIG. 8 is a view illustrating an installation structure of a spray apparatus according to another embodiment of the present invention;

FIG. 9 is a view illustrating a spray apparatus according to still another embodiment of the present invention;

FIG. 10 is a cross-sectional view illustrating a portion A of FIG. 9;

FIG. 11 is a view illustrating a nozzle according to an embodiment of the present invention;

FIGS. 12A and 12B are perspective views illustrating a clothing stand;

FIG. 13 is a diagram illustrating a flow chart showing the steps of a method for treating laundry in accordance with a preferred embodiment of the present invention, and the relationship of control among elements of a laundry treating apparatus in the method.

FIG. 14 is a diagram illustrating a flow chart showing the steps of a method for treating laundry in accordance with another preferred embodiment of the present invention, and the relationship of control among elements of a laundry treating apparatus in the method.

### DETAILED DESCRIPTION

Advantages, features, and methods for achieving the objectives of the embodiments herein may become apparent upon referring to embodiments described later in detail together with attached drawings. However, embodiments are not limited to the embodiments disclosed hereinafter, but may be embodied in different modes. The same reference numbers may refer to the same elements throughout the specification.

Hereinafter, a drying machine among laundry treatment machines will be exemplified, but embodiments are not limited thereto. For example, a laundry treatment method according to an embodiment of the present invention can be applied to other laundry treatment machines such as washing machines with a steam spraying function or washing & drying machines within the scope of the present invention.

The present invention will be described with reference to the attached drawings to describe the drying machine 1 by describing embodiments of the present invention.

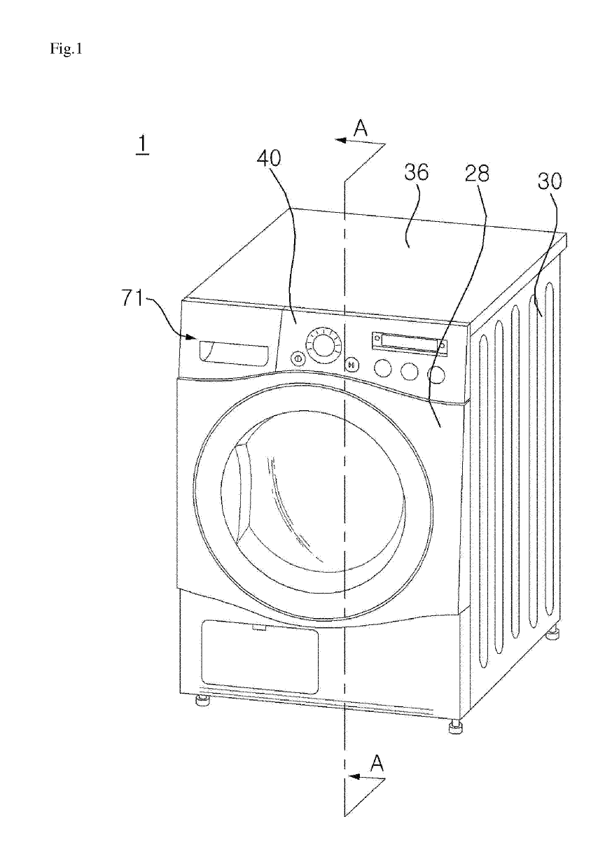

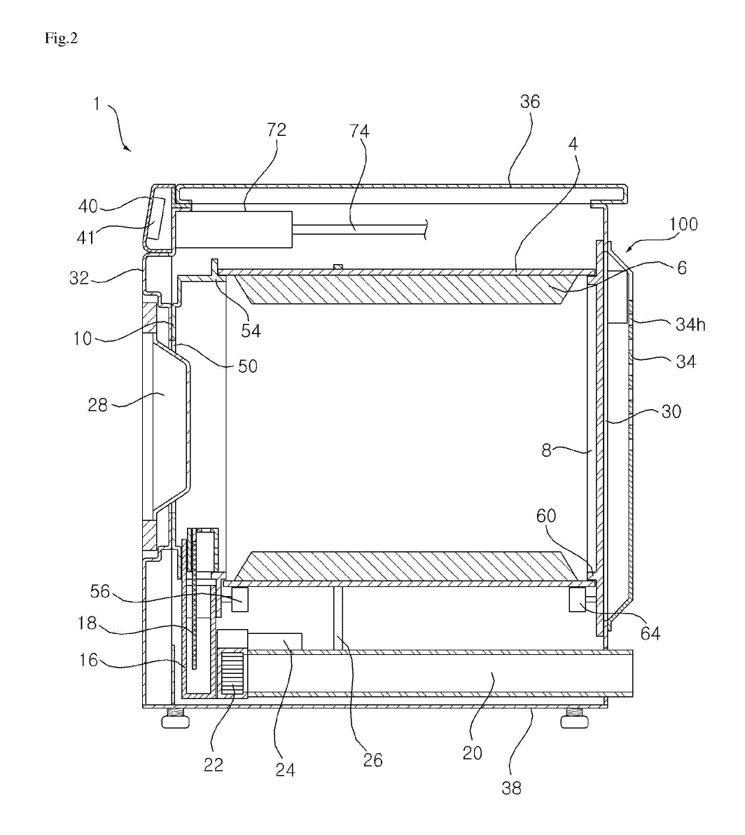

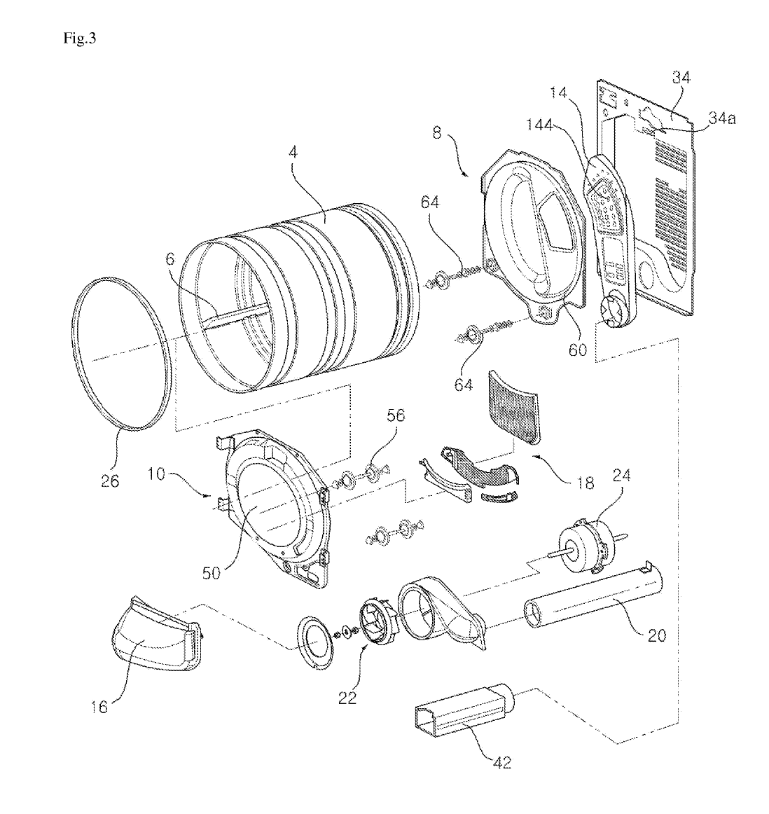

FIG. 1 is a perspective view illustrating a drying machine according to an embodiment of the present invention. FIG. 2 is a cross-sectional view taken along line A-A of FIG. 1. FIG. 3 is an exploded perspective view illustrating a drying machine according to an embodiment of the present invention.

Referring to FIGS. 1 to 3, a drying machine 1 according to an embodiment of the present invention may include a casing defining the exterior thereof and a drum 4 rotatably disposed in the casing and receiving laundry such as clothing. A lifter 6 may be provided on the inner circumferential surface of the drum 4 to tumble clothing according to the rotation of the drum 4.

The casing may include a cabinet 30, a cabinet cover 32, a control panel 40, a back panel 34, a top plate 36, and a base 38. The cabinet cover 32 may be mounted on the front side of the cabinet 30 and may have a clothing loading hole at the center thereof. The control panel 40 may be provided at an upper side of the cabinet cover 32. The back panel 34 may be mounted on the rear side of the cabinet 30 and may have an air hole 34h that allows air to flow in and out of the cabinet 30. The top plate 36 may cover the upper portion of the cabinet 30. The base 38 may be mounted under the cabinet 30. A door 28 may be pivotably coupled to the cabinet cover 32 to open or close the clothing loading hole.

The control panel 40 may include an input unit such as buttons or dials, a display unit such as LCD and LED, and a controller 41. The input unit may receive various kinds of control commands related to the operation of the drying machine from a user. The display unit may visually display the operation state of the drying machine. Also, the controller 41 may be disposed on the rear surface of the control panel 40 to control the overall operation of the drying machine.

In one embodiment, the cabinet 30 may include a water receiving unit 72 that supplies water to a spray apparatus 100. For this, a drawer 71 may be withdrawably supported by the cabinet 30, and a water receiving unit 72 may be held in the drawer 71.

A front support 10 and a rear support 8 may be disposed at the front portion and the rear portion in the casing. The front portion and the rear portion of the drum 4 may be supported by the front support 10 and the rear support 8, respectively.

The central portion of the front support 10 may have an opening 50 communicating with the clothing loading hole. Also, a ring-shaped front supporting protrusion 54 may be formed on the rear surface of the front support 10 to support the front end of the drum 4. Also, a front guide roller 56 may be rotatably disposed at a lower portion of the front support 10. The inner circumferential surface of the front end of the drum 4 may be supported by the front supporting protrusion 54, and the outer circumferential surface thereof may be supported by the front guide roller 56.

A ring-shaped rear supporting protrusion 60 may be formed on the front surface of the rear support 8 to support the rear end of the drum 4, and a rear guide roller 64 may be rotatably disposed at the lower portion of the front surface thereof. The inner circumferential surface of the rear end of the drum 4 may be supported by the rear supporting protrusion 60, and the outer circumferential surface thereof may be supported by the rear guide roller 64.

A drying heater 42 may be disposed under the drum 4. A drying duct 14 communicating between the rear support 8 and the drying heater 42 may be disposed such that air heated by the drying heater 42 can be supplied into the drum 4. A lint duct 16 may be disposed on the front support 10 such that air passing the drum 4 can flow therein.

The drying duct 14 may have a plurality of passage holes 144 such that air can be discharged into the drum 4. Due to a blowing force according to the operation of the blower 22, air may flow along the lint duct 16, the blower 22, and a discharge duct 20. Particularly, during the air flowing, air heated by the drying heater 42 may flow along the drying duct 14, and then may be discharged into the drum 4 through the passage hole 144.

Also, air introduced into the lint duct 16 may be purified by a filter 18. The discharge duct 20 may be disposed at the rear surface of the casing such that air inside the lint duct 16 can be guided to the outside of the casing.

The blower 22 may be disposed between the discharge duct 20 and the lint duct 16. Also, a motor 24 may be provided to generate a driving force of the blower 22 and the drum 4, and a power transmission belt 26 may be provided to rotate the drum through the driving force of the motor 24.

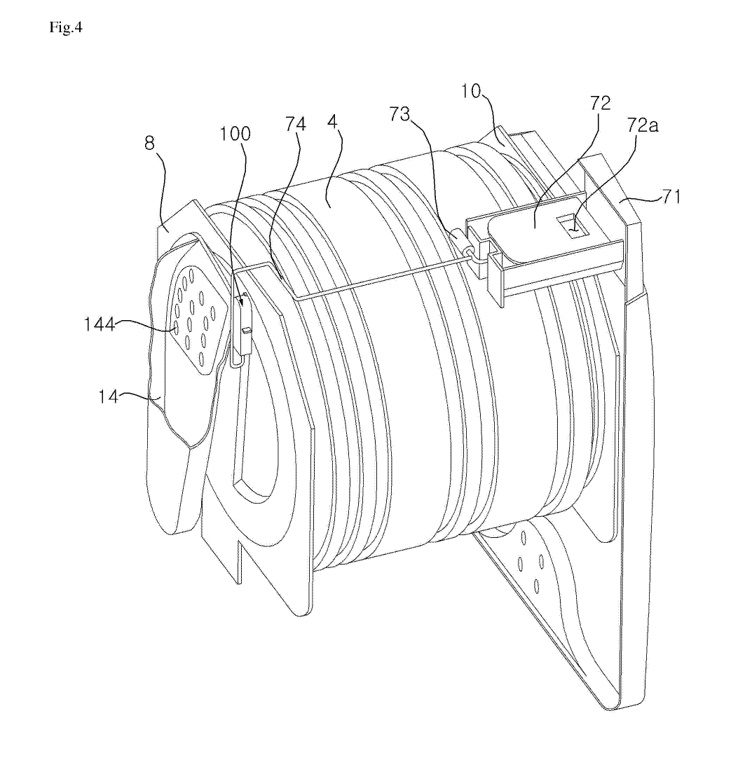

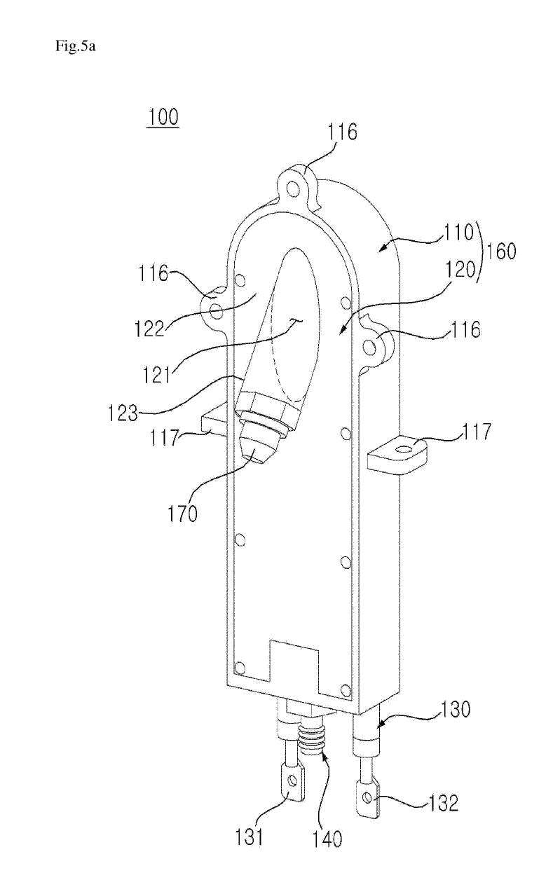

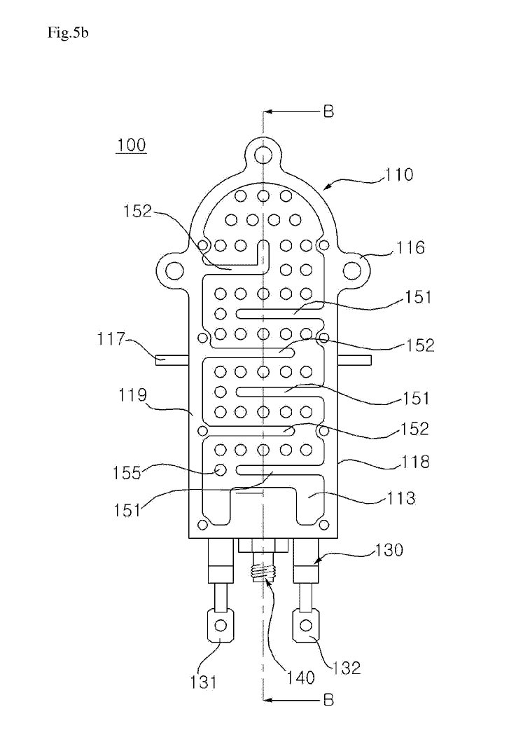

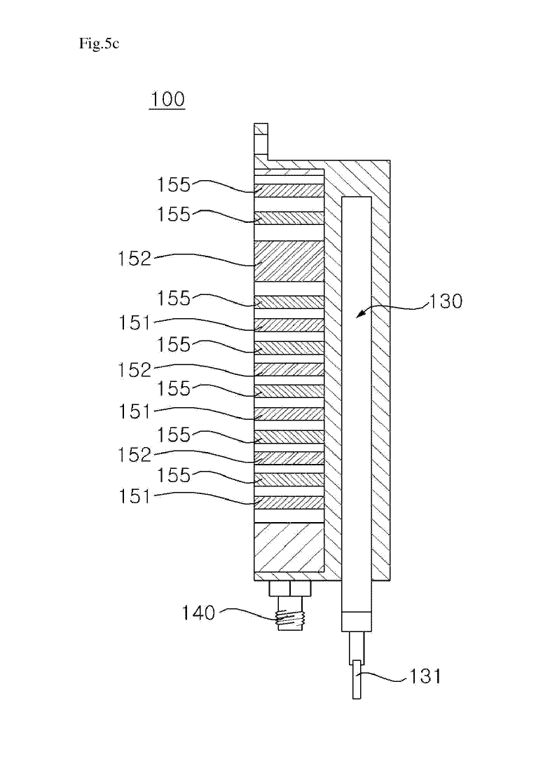

FIG. 4 is a perspective view illustrating the inside of a drying machine including a spray apparatus 100. FIG. 5A is a perspective view of a spray apparatus. FIG. 5B is a view illustrating a flow passage forming unit of a spray apparatus. FIG. 5C is a cross-sectional view taken along line B-B of FIG. 5B.

Referring to FIGS. 4 and 5A, the spray apparatus 100 may spray water into the drum 4. The spray apparatus 100 may include a flow passage forming unit 160 and a steam generating heater 130, and a nozzle 170. The flow passage forming unit 160 may have a flow passage that guides water introduced through the inlet 140 to an outlet 121. The steam generating heater 130 heats the water flowing along the flow passage in the flow passage forming unit 160. The nozzle 170 may spray steam generated by the steam generating heater 130. The nozzle 170 may spray the steam at a certain pressure. The pressure of the injected steam is preferably within a range of 0.2 to 0.4 bars above atmospheric pressure.

Although it will be described in this embodiment that the water receiving unit 72 is separately provided, the flow passage forming unit 160 may be directly supplied with water from an external water resource such as a faucet. In this case, a water supply hose connected to the external water resource may be connected to the inlet 140, and a valve may be further provided between the inlet 140 and the water supply hose to control water supply. A filter may be further provided to filter foreign substances from supplied water.

In this embodiment, the inlet 140 may be connected to the water receiving unit 72 through a water supply pipe 74, and a pump 73 may be provided to forcibly transfer water from the water receiving unit 72 to the flow passage forming unit 160.

The flow passage forming unit 160 may be integrally coupled to the nozzle 170. Here, the meaning of the integral coupling may include a case where the flow passage forming unit 160 and the nozzle 170 are formed into one member by injection molding as well as a case where the flow passage forming unit 160 and the nozzle are separately formed and then form one unit or module. In either case, the location of the nozzle 170 may be determined by the fixed location of the flow passage forming unit 160.

A typical structure in which water is held and heated in a certain container to generate steam and the steam is transferred to the nozzle through the hose has a limitation in that the steam can be condensed and the condensate water can be sprayed through the nozzle, wetting the drying subject again. However, according to an embodiment of the present invention, water may be heated while flowing through the flow passage unit 160, and steam may be sprayed through the nozzle 170 formed integrally with the flow passage forming unit 160. Accordingly, premature condensing of the steam can be prevented while steam generated in the flow passage forming unit 160 is flowing to the nozzle 170.

The water receiving unit 72 may be disposed in the drawer 71. A user may withdraw the drawer 71, and may supply water through a loading hole 72a. Particularly, in case of a drying machine miniaturized for portability, it is advantageous to receive water through the water receiving unit 72 rather than receive water from an external water source.

The flow passage forming unit 160 may include a flow passage main body 110 and a cover 120. The flow passage main body 110 may include a flow passage for guiding water from the inlet 140 to the outlet 121, and may have an upper portion opened. The cover may cover the opened upper portion of the flow passage main body 110. According to an embodiment, the flow passage main body 110 and the cover 120 may be integrally formed. The flow passage main body 110 may have the inlet 140 connected to the water supply pipe 74. Water may be introduced into the flow passage main body 110 through the inlet 140.

The steam generating heater 130 may heat water introduced into the flow passage main body 110. Water may be heated to generate steam according to the heating action of the steam generating heater 130. The steam generating heater may be exposed to the flow passage in which water flows, but in this embodiment, will be described as being buried in a bottom 113 of the flow passage main body 110. Since the steam generating heater 130 is not directly exposed to water, there is an advantage in that a separate insulating structure for the insulation of the steam generating heater 130 is unnecessary. The flow passage main body 110 may be formed of a thermal conductive material such as aluminum such that heat transfer from the steam generating heater 130 can be easily performed.

The steam generating heater 130 may include two terminals 131 and 132 for power supply. The terminals 131 and 132 may outwardly protrude from the flow passage main body 110 to be electrically connected to a power supply.

The flow passage main body 110 may form a certain space such that water can be moved to the inside. A plurality of flow passage forming ribs 151 and 152 may be protrusively formed on the bottom of the flow passage main body 110. The flow passage forming ribs 151 and 152 may form a path along which water moves, and may extend from side portions 118 and 119 of the flow passage main body 110.

The plurality of flow passage forming ribs may include a first flow passage forming rib 151 extending from the right side portion 118 of the flow passage main body 110 and a second flow passage forming rib 152 extending from the left side portion 119 of the flow passage main body 110. The first flow passage forming rib 151 and the second flow passage forming rib 152 may be alternately arranged between the inlet 140 and the nozzle 170.

The end portion of the first flow passage forming rib 151 may be spaced from the left side portion 119 by a certain gap, and the second flow passage forming rib 152 may also be spaced from the right side portion 118 by a certain gap. Water supplied through the inlet 140 may be guided along the plurality of flow passage forming ribs 151 and 152. The traveling direction of water may be alternately switched while flowing to the nozzle 170.

The cover 120 may cover the flow passage main body 110, and may be formed integrally with the flow passage main body 110 or may be coupled to the flow passage main body 110 by a coupling member. In this case, airtightness may be maintained between the cover 120 and the flow passage main body 110 such that steam generated in the flow passage main body 110 does not escape unintentionally.

The cover 120 may include a plate body 122 covering the flow passage main body 110 and a guide tube 123 extending from the outlet 121 formed in the plate body 122 and guiding steam generated in the flow passage main body 110 to the nozzle 170. The nozzle 170 may be coupled to the end portion of the guide tube 123.

The flow passage main body 110 may include a plurality of coupling parts 116 and 117. The coupling parts 116 and 116 may have a coupling hole to which a coupling member is coupled to fix the flow passage main body 110. The opening direction of each coupling hole may be differently configured in consideration of various installation structures. In this embodiment, the opening directions of the coupling hole formed in the first coupling part 116 and the coupling hole formed in the second coupling part 117 may be different from each other.

A plurality of heat transferring protrusions 155 may protrude from the bottom 113 between the first flow passage forming rib 151 and the second flow passage forming rib 152. The plurality of heat transferring protrusions 155 may be spaced from each other. Upon heating of the steam generating heater 130, the bottom 113 of the flow passage main body 110 may be heated, and the flow passage forming ribs 151 and 152 and the heat transferring protrusions 155 may be together heated. This structure has an effect that can secure a wide heating area by heat transferred from the steam generating heater 130 and thus allow water moving between the flow passage forming ribs 151 and 152 to be quickly phase-shifted into steam. If the flow passage main body 110, and particularly, bottom 113 is formed of a thermal conductive material, the heating effect by the flow passage forming ribs 151 and 152 and the heat transferring protrusions 155 may be improved.

The structure in which the traveling direction of water is alternately switched between the flow passage forming ribs 151 and 152 may apply sufficient heat to water flowing along the flow passage. Furthermore, in consideration of the heat effect by the heat transferring protrusion 155, water may be sufficiently heated before reaching the nozzle 170. Particularly, when comparing with a case where steam is generated by heating water held in a certain place, the embodiment has an effect of significantly reducing time necessary in steam spraying because heat is applied to flowing water and thus the phase change is almost instantaneously achieved.

Also, since water is heated while flowing along the flow passage formed in the flow passage forming unit 160, the pressure may increase as water travels downstream along the traveling direction of the water flow, allowing steam to be sprayed at a high pressure through the nozzle 170. In addition to the increased pressure of the steam at the outlet 121, since the pressure of the water flow is added according to the flow of the water to the outlet 121, the spray pressure of the nozzle 170 may be further strengthened.

During the spraying through the nozzle 170, the temperature at the outlet 121 or the inlet of the nozzle 170 may be maintained at about 70° C., and preferably, 70° C. or less, and the internal temperature of the drum 4 may be maintained at a temperature range from about 30° C. to about 40° C. should be noted that when the temperature of steam contacting clothing is too high, clothing may be directly damaged, and secondary contamination may occur due to formation of spots on clothing. However, in this embodiment, since steam is sprayed at or above a certain pressure through the nozzle 170 and the temperature of steam contacting clothing is about 70° C. or less, the damage of clothing can be prevented.

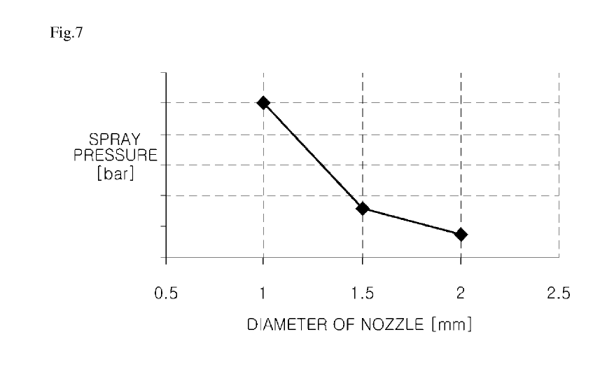

The spray pressure of the nozzle may be closely related with the diameter of the spray hole. Referring to FIG. 7, it can be seen that when the diameter of the spray hole is greater than about 1.5 mm, water sprayed from the nozzle 170 may not hit clothing with a sufficient strength (assuming all other conditions are constant). On the other hand, when the diameter of the spray hole is smaller than about 1 mm, the amount of spray may be insufficient to treat clothing. Also, as the diameter of the spray hole decreases, the possibility of the clogging of the spray hole increases. Accordingly, in consideration of various factors, the diameter of the spray hole of the nozzle 170 may range from about 1.5 mm to about 2 mm. In this case, the nozzle 170 may spray water of about 70 cc to about 120 cc per minute.

Also, since water keeps absorbing heat while flowing along a narrow flow passage defined as a gap between the flow passage forming ribs 151 and 152, when the water flow is divided into upstream and downstream according to the traveling direction from the inlet 140 to the nozzle 170, downstream water may be prone to phase change due to significant heat-absorbing time, and upstream water may also rapidly generate steam at a portion contacting the bottom 113, where a high temperature and pressure state is generated due to a water pressure according to the flowing of the water in addition to the steam, and a high pressure may act from upstream to downstream. Accordingly, steam finally sprayed through the nozzle may be maintained at a very high pressure, and can reach clothing in the drum 4.

That is, since the spray apparatus 100 can generate and spray steam in a short time, time spent on the steam spray cycle can be reduced, and the power consumption can also be reduced. Also, steam can be sprayed at a high pressure.

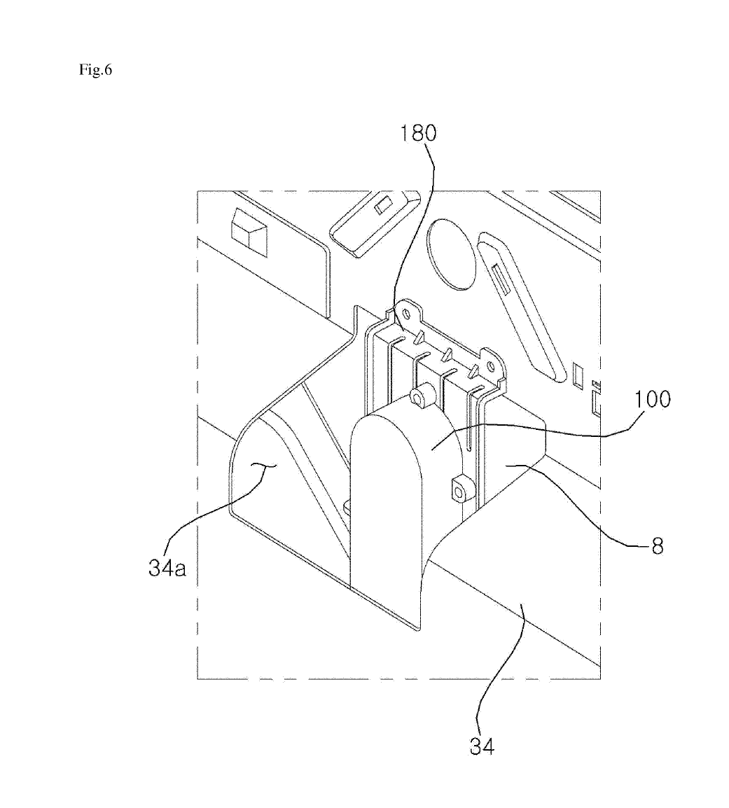

FIG. 6 is a view illustrating a coupling structure of a spray apparatus. FIG. 7 is a graph illustrating a spray pressure according to a spray diameter of a nozzle; Referring to FIGS. 6 and 7, the rear supporter 8 may have a passage hole (not shown) such that steam sprayed from the nozzle 170 can be sprayed into the drum 4. The nozzle 170 may be inserted into the passage hole.

When considering the structure for fixing the steam generating unit 100, the flow passage main body 110 may directly coupled to the rear supporter 8, or may be fixedly coupled to the cabinet 30 or the back panel 34. In this case, the flow passage main body 110 is directly coupled to the cabinet 30 or the back panel 34, or may be coupled to the cabinet 30 or the back panel via a separate bracket 180. In this embodiment, the spray apparatus 100 may be first fixed to the bracket 180, and then the bracket 180 may be coupled to the back panel 34.

The back panel 34 may have an opening 34a for convenience of installation and maintenance of the spray apparatus 100, and the bracket 180 may be coupled around the opening 34a.

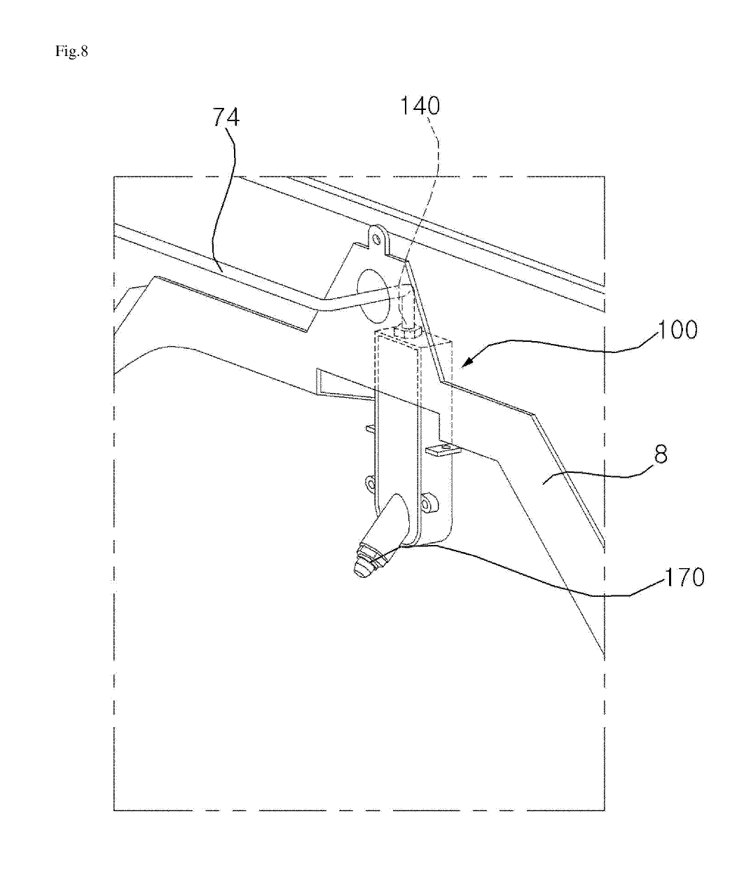

FIG. 8 is a view illustrating an installation structure of a spray apparatus according to another embodiment of the present invention.

Referring to FIG. 8, the flow passage forming unit 160 may be disposed such that the inlet 140 is higher than the nozzle 170. After the pump 73 stops operating, residual water in the flow passage forming unit 160 may be naturally discharged through the nozzle 170. Accordingly, generation of scale and contamination due to residual water in the flow passage forming unit 160 can be prevented. According to an embodiment, the drying machine may perform an operation for cleaning of the flow passage forming unit 160. This cleaning operation may be performed during a cycle provided for the drying function, or may be performed by a separately additional function according to the selection of a user. When this cleaning operation is performed, water may be supplied into the flow passage forming unit 160 to discharge foreign substances such as deposits out of the nozzle 170. The location of the inlet 140 and the nozzle 170 may be determined such that all water supplied through the inlet 140 can be discharged through the nozzle 170 to always maintain the condition that residual water does not exist in the flow passage forming unit 160.

Meanwhile, the amount of steam sprayed from the nozzle 170 and contacting clothing in the drum 4 may be about 40% or more of the total amount of steam generated by heating of the steam generating heater 130. For this, the operational temperature of the steam generating heater 130, the area of the spray hole of the nozzle 170, and the operational pressure of the pump 73 need to be appropriately determined, and particularly, the spray angle of the nozzle 170 may be determined such that steam can be sprayed at an angle of about 30 degrees to about 60 degrees with respect to the horizontal plane.

Steam sprayed through the nozzle 170 needs to contact clothing. Steam sprayed from the nozzle 170 may reach the lowermost portion of the drum 4 such that steam can be applied to clothing regardless of the amount of clothing loaded in the drum 4.

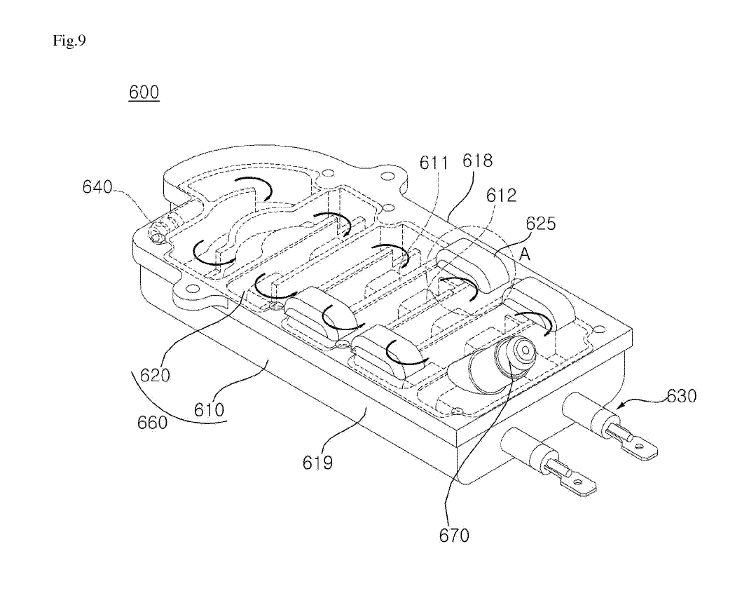

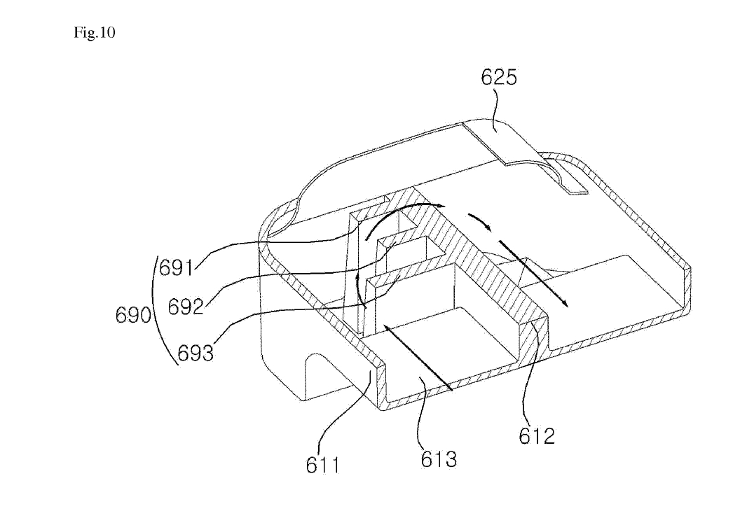

FIG. 9 is a view illustrating a spray apparatus according to still another embodiment of the present invention. FIG. 10 is a cross-sectional view illustrating a portion A of FIG. 9.

Referring to FIGS. 9 and 10, a spray apparatus 600 according this embodiment may include a flow passage forming unit 660 and a nozzle 670 like the above-described embodiments. Also, although indicated as different reference numerals, a flow passage main body 610, a cover 620, a steam generating heater 630, a left side portion 619, and a right side portion 618 will follow the description of the previous embodiments. Accordingly, the description of this embodiment will be focused on differences from the previous embodiments.

In this embodiment, the flow passage forming unit 660 may include a plurality of flow passage forming ribs 611 and 612 protruding from the bottom 613, and may be divided into separate spaces based on one of the flow passage forming ribs 611 and 612. Also, the flow passage forming unit 660 may have a gap for movement of water at an upper side of the flow passage forming rib 612 such that water can overflow the flow passage forming rib 612 while traveling from the upstream side to the downstream side. In order to provide the gap for the movement of water, a gap forming section 625 may be formed in the cover 620. In the gap forming section 625, the inner side surface of the cover 620 may be spaced from the flow passage forming rib 612.

An impactor 690 may be provided in the flow passage forming unit 660, and may extend from the flow passage forming rib 611, 612. The impactor 690 may protrude in plurality toward the space pertaining to the upstream side among the separate spaces based on the flow of water.

The impactor 690 may be formed at a location corresponding to the gap forming section 625. Water flowing in the flow passage forming unit may be hit by the impactor 690 at the space pertaining to the upstream side of the separate spaces divided by the flow passage forming rib 611, 612, and then may travel to the space pertaining to the downstream side through the gap forming section 625. When this process is continuously repeated, scale may be mainly generated among the impactors 691, 692 and 693. Accordingly, the spray hole of the nozzle 670 can be prevented from clogging.

The impactor 690 may be formed at a plurality of locations, particularly, at sections where the flow direction is switched. The flow passage forming rib may be partially cut such that the water flow can travel even though the gap forming section 625 is not formed at a section where the impactor 690 is not installed among the sections where the flow direction is switched.

Although not shown, the spray apparatus 600 may be configured such that the inlet 640 is disposed over the nozzle 670. Similarly to the embodiment described with reference to FIG. 8, this structure is advantageous to discharging of residual water in the flow passage forming unit 660.

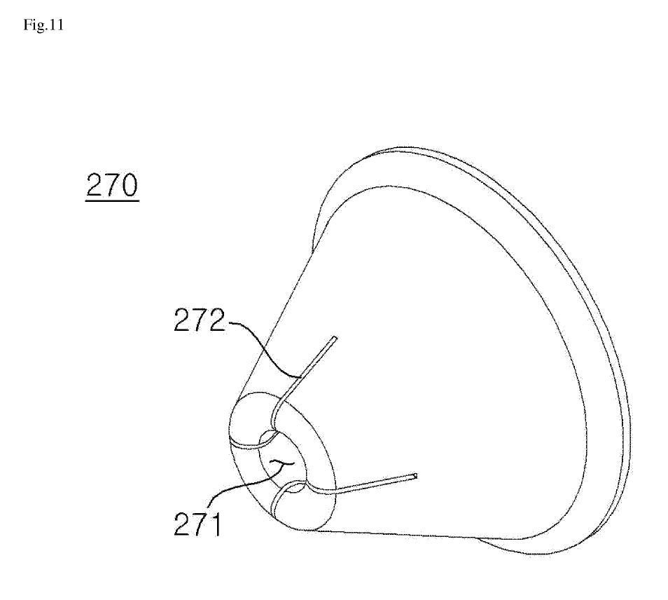

FIG. 11 is a view illustrating a nozzle according to an embodiment of the present invention. Referring to FIG. 11, a spray apparatus according to an embodiment may include a nozzle varying in the area of the spray hole according to the water pressure. Thus, although the spray hole is narrowed due to scale generated by the continuous use of the spray apparatus, a spray amount of a certain level or more can be secured. This nozzle can be implemented in various types. It will be noted that a nozzle 270 described herein can be applied to any one of the spray apparatus described in the previous embodiments.

The nozzle 270 may be formed of a deformable material. The nozzle 270, particularly, the spray hole may be deformed according to the spray pressure. Although scale is generated around the spray hole, since the area of the spray hole varies, a spray amount of at least a certain level can be secured, and foreign substances in the flow passage forming units 160 and 660 can also be discharged to the outside.

The spray hole of the nozzle 270 may be cut along the edge thereof multiple times. As the cut portions spread out according to the spray pressure, the diameter of the spray hole of the nozzle 270 may increase.

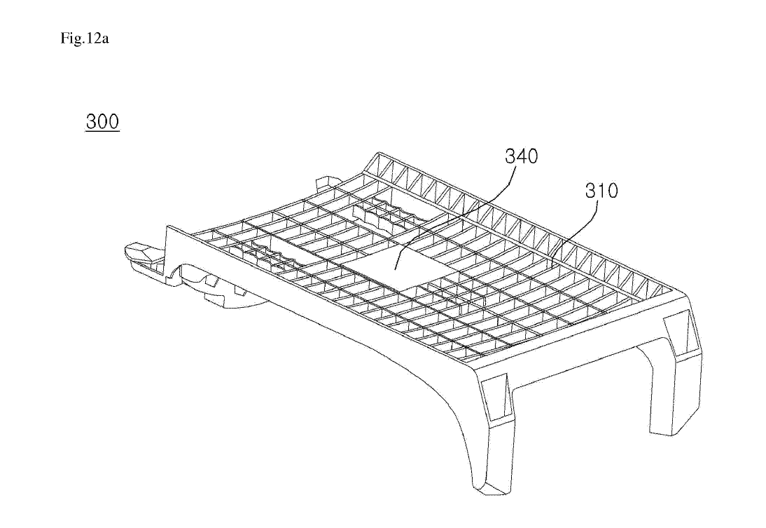

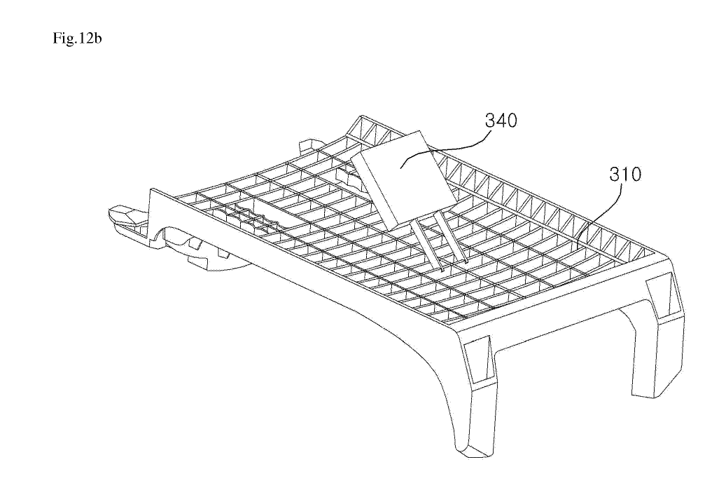

FIGS. 12A and 12B are perspective views illustrating a clothing stand. Referring to FIGS. 12A and 12B, a clothing stand 300 may allow clothing to be placed thereon when clothing is washed through the spray apparatus 100 and 600. Here, the meaning of washing is a process of removing contaminants by applying steam and detergent by spraying. The steam and detergent are applied to clothing through the spray apparatus 100 and 600 unlike a washing cycle or operation performed by a typical washing machine. Since steam is used, the amount of water required for washing is smaller than that required for typical washing. Accordingly, washing is more efficient, and local contaminants such as spots on clothing can be conveniently removed. Moreover, it is possible to install the spray apparatus 100 and 600 in a typical drying machine to provide a washing function.

The clothing stand 300 may include a base 310 and a support plate 340. The support plate 340 may be pivotably disposed in the base 310, and may adjust the contaminated part of clothing so as to face the spray direction of the nozzle 170. A user may place clothing on the clothing stand such that the contaminated part is located on the support plate 340, and then may adjust the angle of the support plate 340 so as to face the nozzle 170 such that steam and detergent sprayed through the nozzle 170 accurately reaches the contaminated part. The maximum pivotable angle of the support plate 340 may be set corresponding to the spray direction of the nozzle 170. The clothing stand 300 may be detachably disposed in the drum 4 such that a user can arbitrarily attach or detach the clothing stand 300 only when necessary. The laundry stand 300 may be detachably disposed in the drum 4 such that a user can arbitrarily attach or detach the clothing stand 300 only when necessary.

A method for treating laundry by the drying machine 1 of the present invention having the foregoing configuration will be described.

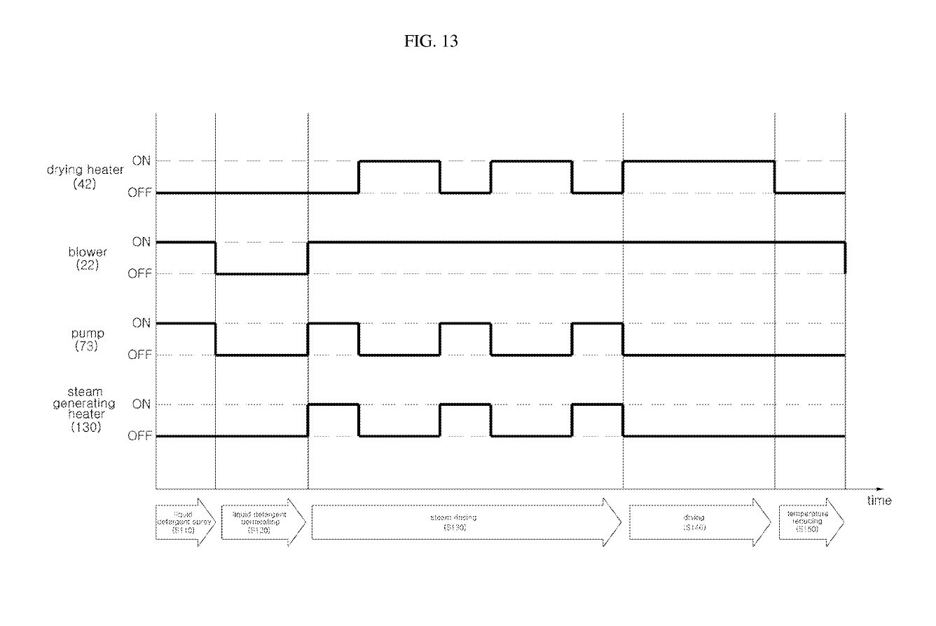

FIG. 13 is a diagram illustrating a flow chart showing the steps of a method for treating laundry in accordance with a preferred embodiment of the present invention, and the relationship of control among elements of a laundry treating apparatus in the method.

Referring to FIG. 13, the method for treating laundry in accordance with a preferred embodiment of the present invention includes a liquid detergent spraying step S110 for spraying a liquid detergent having a detergent for spraying dissolved therein toward laundry in a drum 4, a liquid detergent permeating step S120 for waiting for a predetermined time period to allow the liquid detergent to be absorbed in the laundry, a steam rinsing step S130 for spraying high temperature steam toward the laundry to rinse the laundry, and a drying step S140 for supplying heated air to the drum 4 to dry the laundry having the steam absorbed therein.

The detergent for spraying in accordance with an embodiment of the present invention is a liquid detergent. The liquid detergent leaves no deposit of the detergent in the laundry treating process, and is easily sprayed to the laundry by using a spray apparatus 100, 600.

The detergent for spraying includes a detergent composition consisting of polyoxyethylene alkylether, sodium ethylhexyl sulfate, sodium hydroxide, 2-Ethyl Hexanol, Alcohols, Glycol ether, Chelating agent, and water. The detergent for spraying is a spot cleaning detergent used for removing local dirt from the laundry. Therefore, it is preferable that the detergent for spraying is used in a case the detergent is sprayed to a source of contamination of the laundry fixed by using a clothing stand 300.

The polyoxyethylene alkylether is a kind of nonionic detergent having higher alcohol ether coupled to polyoxyethylene to serve as a detergent for removing water soluble dirt and oily dirt, such as cutaneous tallow, from the laundry. In general, the polyoxyethylene alkylether is used as a main raw material of a super concentrated liquid detergent. The super concentrated liquid detergent having the polyoxyethylene alkylether included thereto can wash even with a small amount of water and at a low temperature in winter. Moreover, in order to enhance functionability, such as having only one rinsing cycle, other nonionic surfactants may be added thereto. The detergent for spraying includes 5 to 10 wt % of polyoxyethylene alkylether.

The sodium ethylhexyl sulfate, a kind of surfactant, serves as detergent for removing the water soluble dirt and the cutaneous tallow from the laundry. The detergent for spraying includes 3 to 5 wt % of the sodium ethylhexyl sulfate.

The sodium hydroxide serves as a detergent supplement which supplements the detergent for removing the water soluble dirt and cutaneous tallow from the laundry. The detergent for spraying includes 1 to 2 wt % of the sodium hydroxide.

The 2-Ethyl Hexanol serves to separate the cutaneous tallow from the laundry. The detergent for spraying includes 1 to 2 wt % of the 2-Ethyl Hexanol.

The alcohols serves as a stabilizer. The detergent for spraying includes 0.1 to 5 wt % of the alcohols.

The Glycol ether serves as a stabilizer to remove the oily dirt, such as the cutaneous tallow. The detergent for spraying includes 0.1 to 5 wt % of the Glycol ether.

The Chelating agent serves as a sequestering agent. The detergent for spraying includes 0.1 to 1 wt % of the Chelating agent.

Accordingly, the detergent for spraying consists of 5 to 10 wt % of polyoxyethylene alkylether, 3 to 5 wt % of sodium ethylhexyl sulfate, 1 to 2 wt % of sodium hydroxide, 1 to 2 wt % of 2-Ethyl Hexanol, 0.1 to 5 wt % of alcohols, 0.1 to 5 wt % of Glycol ether, 0.1 to 1 wt % of Chelating agent, and the balance of water.

TABLE 1

| COMPONENT | FUNCTION | CONTENT (%) |
|---|---|---|
| Polyoxyethylene | Removal of water soluble dirt | 5~10 |
| alkyl ether | and oily dirt | |
| Sodium ethylhexyl | Removal of water soluble dirt | 3~5 |
| sulfate | and oily dirt | |
| Sodium hydroxide | Supplements washing | 1~2 |
| 2-Ethyl Hexanol | Separates oily dirt | 1~2 |
| Alcohols | Stabilizer | 0.1~5 |
| Glycol ether | Removes oily dirt and stabilizer | 0.1~5 |
| Chelating agent | Sequestering agent | 0.1~1 |
| Water | | balance |

A method for treating laundry by using a detergent for spraying in accordance with a preferred embodiment of the present invention will be described.

Before the liquid detergent spraying step S110, the user places laundry on a clothing stand 300 mounted in the drum 4, such that the spraying apparatus 100, 600 can accurately spray the liquid detergent and the steam toward the laundry having a contamination source.

The liquid detergent spraying step S110 may be performed by the spraying apparatus 100, 600 described in the foregoing embodiments, and, in this case, though a pump 73 is operated, the steam generating heater 130 is not operated.

Depending on embodiments, a water supply pipe 74 may supply the detergent to the spraying apparatus 100, 600 through a detergent receiving unit, or a detergent supply device may further be provided for supplying the liquid detergent to the spray apparatus 100, 600, directly.

For another embodiment, the user may introduce the detergent to the water receiving unit 72. In this case, both the detergent in the water receiving unit 72 and the water is consumed in the liquid detergent spraying step S110, and supply of the water is again required for the steam rinsing step S130.

For yet another embodiment, the water receiving unit 72 which has water required for generation of the steam filled therein and a detergent receiving unit which has the liquid or a powder detergent filled therein may be provided separately, and the spray can be made with the same spray apparatus 100, 600 both in the liquid detergent spraying step S110 and the steam rinsing step S130. However, in this embodiment, both the water in the water receiving unit 72 and the detergent in the detergent receiving unit is supplied to the spray apparatus 100, 600 separately, but at the same time, and in the steam rinsing step S130, though the water in the water receiving unit 72 is supplied, supply of the detergent from the detergent receiving unit is stopped.

For another embodiment, it is possible to construct a flow passage such that the water is supplied to the spray apparatus 100, 600 through the detergent receiving unit provided for receiving the liquid or powder detergent, to make the spray by using the water supplied through the flow passage in both of the liquid detergent spraying step S110 and the steam rinsing step S130. In this case, in the liquid detergent spraying step S110, all of the detergent in the detergent receiving unit is supplied to the spray apparatus 100, 600 and sprayed therefrom. Therefore, in the steam rinsing step S130 which is performed thereafter, even if the water is supplied to the spray apparatus 100, 600 through the detergent receiving unit, water having no detergent dissolved therein is supplied, and the steam sprayed through the nozzle 170 also has no detergent dissolved therein.

The liquid detergent spraying step S110 may further include a step for blowing air to the drum 4 while the liquid detergent is sprayed toward the laundry in the drum 4, wherein, though the pump 73 is put into operation during spray of the liquid detergent, operation of the steam generating heater 130 is turned off, and, in addition to this, the blower 22 is put into operation for blowing air. The liquid detergent spraying step S110 may require 20 seconds to a few minutes, but preferably, 20 seconds. It is preferable that an amount of the liquid detergent sprayed to the laundry in the liquid detergent spraying step S110 is about 30 ml.

In the liquid detergent permeating step S120, the liquid detergent permeates the laundry. Preferably, in the liquid detergent permeating step S120, operation of the drying heater 42 and the blower 22 are turned off such that no more liquid detergent is sprayed (pump 73 is also turned off), and a wet state of the contaminated portion of the laundry is maintained. However, depending on the embodiment, though operation of the drying heater 42 is turned off, the operation of the blower 22 may not be turned off in the liquid detergent permeating step S120. The liquid detergent permeating step S120 may takes 1 to 5 minutes, but preferably, 4 minutes.

The steam rinsing step S130 is a step for washing or rinsing the laundry treated with the liquid detergent. Steam spray is made with the spray apparatus 100, 600. The dirt stuck to the laundry is removed from the laundry by a physical impact of the water sprayed from the spray apparatus 100, 600 onto the contaminated portion and a chemical reaction in which the detergent is dissolved by the water sprayed thus. Since it is a state after which the detergent has permeated the laundry adequately, the source of the contamination is removed, smoothly. It is required that the spray is made for a sufficient time period for removing the liquid detergent from the laundry.

In the steam rinsing step S130, in addition to the operation of the pump 73 and the steam generating heater 130, the drying heater 42 may be operated for maintaining or elevating a temperature in the drum 4, and the blower 22 may be operated for blowing air heated at the drying heater 42 to an inside of the drum 4. According to this, the temperature in the drum 4 dropped in the liquid detergent permeating step S120 may be elevated to a certain level, again. If the spray of the water can be made by a water pressure of a water supply source which supplies the water to the spray apparatus 100, 600, the operation of the pump 73 may be omitted.

A temperature of the steam sprayed through the spray apparatus 100, 600 in the steam rinsing step S130 may be about 70° C. at an inlet to the nozzle 170, and preferably lower than 70° C. In this case, the temperature in the drum 4 may be maintained at 30° C. to 40° C. Preferably, the temperature in the drum 4 may be maintained at 30° C. to 40° C. throughout the liquid detergent spraying step S110, the liquid detergent permeating step S120, and the steam rinsing step S130.

A temperature sensor (not shown) may be provided for sensing the temperature of the drum 4. In this case, the controller 41 may control operation of the pump 73, the steam generating heater 130, the drying heater 42, and/or the blower 22 for maintaining the temperature in the drum at 30° C. to 40° C. according to a sensed value of the temperature sensor.

In the steam rinsing step S130, of the water sprayed by the spray apparatus 100, 600, it is preferable that an amount of sprayed water brought into contact with the laundry is more than 40% of an entire amount of the steam generated by the steam generating heater 130. Specifically, the steam sprayed through the spray apparatus 100, 600 may be directed into the drum 4 at an angle of about 30° to 60° from a horizontal plane. Preferably, the steam sprayed from the spray apparatus 100, 600 has an angle set to be sprayed to the contaminated portion of the laundry fixed to the clothing stand 300.

In the steam rinsing step S130, the steam is sprayed with the spray apparatus 100, 600 at predetermined time intervals. Preferably, the steam may be sprayed to the contamination source of the laundry at 4 to 5 minute intervals. Thus, by dividing a spray time into many smaller interval times in the steam rinsing step S130, an effect can be obtained in which it is possible to prevent contaminated water formed when the steam is sprayed from being held in the drum 4. Preferably, the steam is sprayed about three times in the steam rinsing step S130.

In the steam rinsing step S130, the steam spray may take 20 to 40 seconds, and preferably, 30 seconds. In a time period in which the steam is not sprayed in the steam rinsing step S130, the drying heater 42 may be put into operation for maintaining or elevating the temperature in the drum 4, and the blower 22 may be put into operation for blowing the air heated by the drying heater 42 to the drum 4.

It is recommended to wash clothes of a material of wool, hemp fiber, polyester, or nylon at a temperature below 40° C., clothes of a material of acetate, or silk at a temperature below 35° C., clothes of a material of acryl, denim, or rayon at a temperature of 27° C.˜32° C., and clothes of a material of down feather at a temperature of 38° C.˜43° C.

Though it is preferable that the cutaneous tallow shed from a human body, which is a typical clothes contaminant, having a melting point of approximately 37° C. is washed at a temperature higher than the melting point, protein coagulates or denatures at a temperature higher than 42° C., a color of the clothes is liable to damage at a temperature higher than 43° C., and removal of blood stain from the clothes is easy at a temperature in a range of 36° C.˜38° C.

In the method for treating laundry in accordance with a preferred embodiment of the present invention, the contamination sources are treated with the liquid detergent sprayed thus in the liquid detergent spraying step S110, and the liquid detergent permeates deep into the laundry in the liquid detergent permeating step S120 to dissolve the contamination sources by a soaking action and activity of the detergent, bringing about a state in which removal of the contamination sources becomes easier. Thereafter, the removal or separation of the contamination sources from the laundry is achieved physically by the high temperature and high pressure steam sprayed to the laundry in the steam rinsing step S130. Even if the sprayed steam is brought into contact with the laundry in the steam rinsing step S130, since the steam is applied to the laundry in a wet state after the liquid detergent spraying step S110 and adequate liquid detergent permeating step S120, the coagulation or denaturing of the contamination sources stuck to the laundry is prevented.

In particular, the water soluble contamination and the oily dirt, such as the cutaneous tallow, enters a state in which removal is easy owing to the chemical action of polyoxyethylene alkylether, sodium ethylhexyl sulfate, sodium hydroxide, and 2-Ethyl Hexanol included to the detergent for spraying while passed through the liquid detergent spraying step S110, and the liquid detergent permeating step S120. According to this, the steam sprayed in the steam rinsing step S130 can remove the water soluble dirt and the oily dirt, such as the cutaneous tallow, effectively.

In conclusion, the method for treating laundry of the present invention can, not only prevent denaturing or coagulation of the contamination sources as the contamination sources are passed through the liquid detergent spraying step S110, the liquid detergent permeating step S120, and the steam rinsing step S130 even if kinds of the contamination sources vary, but also remove the oily dirt, such as the cutaneous tallow, and the water soluble dirt, effectively.

Not only is a substantial portion of the contamination stuck to the laundry removed during the steam rinsing step S130, but problems of the coagulation or denaturing of the protein or denaturing of the clothes do not take place even if the temperature inside of the drum 4 is elevated by putting the drying heater 42 into operation owing to an adequate quantity of the water absorbed in the laundry.

The drying step S140 is a step in which the washed or rinsed laundry in the steam rinsing step S130 is dried. The steam spray from the spray apparatus 100, 600 is stopped, and cold air or heated air is blown to an inside of the drum 4. The blower 22 may be put into operation for blowing the air, and, particularly, the drying heater 42 may be put into operation for drying the laundry within a short time period. The drying step S140 takes 5 to 10 minutes.

The steam rinsing step S130 and the drying step S140 may be repeated. Therefore, the repetition of the rinsing and drying of the laundry enables effective removal of the detergent remained on the laundry.

A temperature reducing step S150 is a step for cooling the laundry dried thus by blowing the cold air to an inside of the drum 4 after the drying step S140. In the temperature reducing step S150, the temperature inside of the drum 4 is reduced for preventing accidents, such as burns, from taking place, which can be caused by high temperature air being discharged when the user opens the door 28 for taking out the dried laundry. During the temperature reducing step S150, the spray via the spray apparatus 100, 600 is stopped and the blower 22 is operated. In this case, the drying heater 42 is also turned off. Preferably, the temperature reducing step S150 is finished within 1 minute. Or, alternatively, as another embodiment, in the temperature reducing step S150, a preset time period may be waited for cooling down the dried laundry after the drying step S140.

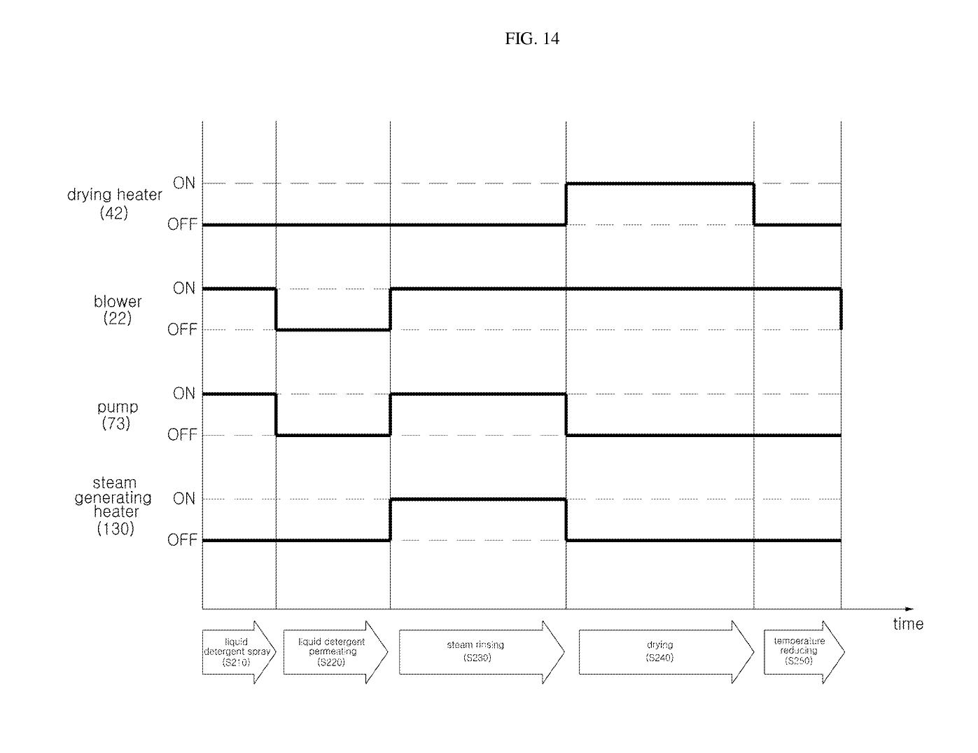

FIG. 14 is a diagram illustrating a flow chart showing the steps of a method for treating laundry in accordance with another preferred embodiment of the present invention, and the relationship of control among elements of a laundry treating apparatus in the method.

Referring to FIG. 14, the method for treating laundry in accordance with another preferred embodiment of the present invention includes a liquid detergent spraying step S210 for spraying a liquid detergent having a dissolved detergent for spraying toward laundry in a drum 4, a liquid detergent permeating step S220 for waiting for a predetermined time period to allow the liquid detergent to be absorbed in the laundry, a steam rinsing step S230 for spraying high temperature steam toward the laundry to rinse the laundry, a drying step S240 for supplying heated air to the drum 4 to dry the laundry having the steam absorbed therein S140, and a temperature reducing step S250 for cooling down the laundry dried thus. Description of terms will be identical to the foregoing embodiment even if reference numerals thereof in the method for treating laundry in accordance with another preferred embodiment of the present invention are different from the foregoing embodiment, and the method for treating laundry in accordance with this other preferred embodiment of the present invention will be described with focus on differences from the method for treating laundry in accordance with a preferred embodiment of the present invention.

The detergent for spraying used in another embodiment of the present invention will be described. The detergent for spraying in accordance with the embodiment is a liquid detergent. The liquid detergent leaves no deposit of the detergent in the laundry treating process, and is easily sprayed to the laundry by using a spray unit 100 at the time of spray.

The detergent for spraying includes a detergent composition consisting of polyoxyethylene alkylether, sodium ethylhexyl sulfate, sodium hydroxide, 2-Ethyl Hexanol, Alcohols, Glycol ether, Chelating agent and water.

The polyoxyethylene alkylether is a kind of nonionic detergent having higher alcohol ether coupled to polyoxyethylene to serve as a detergent for removing water soluble dirt and oily dirt, such as cutaneous tallow, from the laundry. In general, the polyoxyethylene alkylether is used as a major raw material of a super concentrated liquid detergent. The super concentrated liquid detergent having the polyoxyethylene alkylether included thereto can wash even with a small amount of water and at a low temperature of winter. Moreover, in order to enhance functionability, such as only one time finishing of rinsing, other nonionic surfactant is added thereto. The detergent for spraying includes 5 to 10 wt % of polyoxyethylene alkylether.

The sodium ethylhexyl sulfate, a kind of surfactant, serves as detergent for removing the water soluble dirt and the cutaneous tallow from the laundry. The detergent for spraying includes 3 to 5 wt % of the sodium ethylhexyl sulfate.

The sodium hydroxide serves as a detergent supplement which supplements the detergent for removing the water soluble dirt and cutaneous tallow from the laundry. The detergent for spraying includes 1 to 2 wt % of the sodium hydroxide.

The 2-Ethyl Hexanol serves to separate the cutaneous tallow from the laundry. The detergent for spraying includes 1 to 2 wt % of the 2-Ethyl Hexanol.

The alcohols serve as a stabilizer. The detergent for spraying includes 01 to 5 wt % of the alcohols.

The Glycol ether serves as a stabilizer to remove the oily dirt, such as the cutaneous tallow. The detergent for spraying includes 0.1 to 5 wt % of the Glycol ether.

The Chelating agent serves as a sequestering agent. The detergent for spraying includes 0.1 to 1 wt % of the Chelating agent.

Accordingly, the detergent for spraying consists of 5 to 10 wt % of polyoxyethylene alkylether, 3 to 5 wt % of sodium ethylhexyl sulfate, 1 to 2 wt % of sodium hydroxide, 1 to 2 wt % of 2-Ethyl Hexanol, 0.1 to 5 wt % of alcohols, 0.1˜5 wt % of Glycol ether, 0.1 to 1 wt % of Chelating agent, and balance of water.

TABLE 2

| COMPONENT | FUNCTION | CONTENT (%) |
|---|---|---|
| Polyoxyethylene | Removal of water soluble dirt | 5~10 |
| alkyl ether | and oily dirt | |
| Sodium ethylhexyl | Removal of water soluble dirt | 3~5 |
| sulfate | and oily dirt | |
| Sodium hydroxide | Supplements washing | 1~2 |
| 2-Ethyl Hexanol | Separate oily dirt | 1~2 |
| Alcohols | Stabilizer | 0.1~5 |
| Glycol ether | Removes oily dirt and stabilizer | 0.1~5 |
| Chelating agent | Sequestering agent | 0.1~1 |
| Water | | balance |

And, the detergent for spraying further includes deodorant including at least one of a fiber softener including a cationic surfactant, a wrinkle prevent agent including silicone oil, and odor neutralizer. Therefore, the detergent for spraying has a fiber softening performance, a crease preventive performance, and a deodorant performance while the detergent for spraying is a spot cleaning detergent. Accordingly, since fiber softener, wrinkle prevent agent, and deodorant are not required to put in the drum, a laundry treating process can be reduced.

The detergent for spraying can be used, not only when the laundry having the contamination is fixed to the clothing stand 300, and the detergent is sprayed to the laundry fixed thus, but also in a case where the detergent is sprayed to the laundry tumbling in the drum 4.

Though a method for treating laundry tumbling in a drum 4 in accordance with another preferred embodiment of the present invention will be described in detail, detailed description of a method for treating laundry identical to the foregoing embodiment will be omitted.

Before the liquid detergent spraying step S210, the laundry is placed in the drum 4. Then, as the drum 4 rotates, the laundry in the drum 4 tumbles, and the spray apparatus 100, 600 sprays the liquid detergent or the steam to the laundry tumbling in the drum 4.

In the liquid detergent spraying step S210, the liquid detergent may be sprayed with the spray apparatus 100, 600 described in the foregoing embodiments, and in this case, though the pump 73 and the drum 4 are operated, the steam generating heater 130 is turned off. In the liquid detergent spraying step S210, the liquid detergent is sprayed to the laundry tumbling in the drum 4. Therefore, the liquid detergent may be sprayed throughout the laundry, uniformly. The liquid detergent spraying step S210 may take 10 seconds to a few minutes.

In the liquid detergent permeating step S220, the liquid detergent permeates the laundry. The liquid detergent permeating step S220 may take 1 to 5 minutes, but preferably, 4 minutes. Since operation of the drum 4 is stopped in the liquid detergent permeating step S220, rotation of the drum 4 is stopped.

In the steam rinsing step S230, the spray is made for 1 to 2 minutes for removing the liquid detergent from the laundry. Different from a case in which the laundry having contaminant is fixed to the clothing stand 300 and the detergent is sprayed to the contamination source of the laundry fixed thus, the steam is sprayed, not at fixed time intervals, but continuously for a preset time period.

And, in the steam rinsing step S230, the drum 4 is put into operation again, to make the laundry in the drum 4 to tumble. According to this, the steam is uniformly sprayed to the laundry treated with the liquid detergent with the spray apparatus 100, 600, for washing or rinsing the laundry.

The drying step S240 is a step for drying the laundry washed or rinsed in the steam rinsing step S230. The steam spray with the spray apparatus 100, 600 is stopped, and cold air or a heated air is blown to an inside of the drum 4. The blower 22 may be operated for blowing the air, and, in particular, the drying heater 42 may be operated for drying the laundry within a short time period. The drying step S240 takes 5 to 10 minutes. In the drying step S240, the drum 4 is operated, and the laundry in the drum 4 tumbles. Accordingly, the cold air or the heated air is uniformly applied to the laundry washed or rinsed thus.

In the meantime, in the foregoing description, the pump 73, the steam generating heater 130, the blower 22, the drying heater 42 and so on operated in respective steps are not required to be operated throughout the respective steps, but the operation may be intermittent under the control of the controller 41. For an example, operation and pause may be repeated in fixed time intervals. Or, different from this, the operation and pause may be controlled according to a preset temperature or a flow rate based on a measured value at a temperature sensor (not shown) or a flow rate sensor (not shown).

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for treating laundry comprising:
spraying a liquid comprising dissolved detergent into a drum holding laundry;
delaying for a predetermined time period after spraying the liquid, to allow the detergent to be absorbed in the laundry;
spraying steam into the drum to rinse the laundry; and
supplying heated air into the drum to dry the laundry,
wherein the detergent comprises:
5 to 10 wt % of polyoxyethylene alkylether,
3 to 10 wt % of sodium ethylhexyl sulfate, and
balance of water.

2. The method of claim 1, wherein the detergent further comprises:
1 to 2 wt % of sodium hydroxide, and
1 to 2 wt % of 2-Ethyl Hexanol.

3. The method of claim 1, wherein the detergent further comprises:
0.1 to 5 wt % of Alcohols,
0.1 to 5 wt % of Glycol ether, and
0.1 to 1 wt % of a Chelating agent.

4. The method of claim 1, wherein the detergent further comprises:
deodorant including at least one of a fiber softener including a cationic surfactant, a wrinkle prevent agent including silicone oil, and odor neutralizer.

5. The method of claim 1, wherein the spraying steam comprises spraying steam at predetermined time intervals.

6. The method of claim 1, further comprising:
cooling down the laundry after supplying heated air.

7. The method of claim 1, wherein spraying the liquid and spraying steam are performed using a same nozzle.

8. The method of claim 1, wherein the spraying the liquid comprises spraying the liquid toward the laundry mounted to a clothing stand provided in the drum.

9. The method of claim 4, wherein the liquid is sprayed while the laundry is tumbled by a rotation of the drum.

10. A detergent comprising:
5 to 10 wt % of polyoxyethylene alkylether;
3 to 5 wt % of sodium ethylhexyl sulfate; and
balance of water.

11. The detergent of claim 10, further comprising;
1 to 2 wt % of sodium hydroxide, and
1 to 2 wt % of 2-Ethyl Hexanol.

12. The detergent of claim 11, further comprising:
0.1 to 5 wt % of Alcohols;
0.1 to 5 wt % of Glycol ether; and
0.1 to 1 wt % of Chelating agent.

13. The detergent of claim 10, further comprising:
deodorant including at least one of a fiber softener including a cationic surfactant, a wrinkle prevent agent including silicone oil, and odor neutralizer.

14. A spray apparatus, comprising:
a flow passage forming unit to form a flow passage;
an inlet connected to one end of the flow passage and an outlet connected to the other end of the flow passage,
wherein the flow passage guides water introduced through the inlet to the outlet;
a steam generating heater to heat the water flowing along the flow passage; and
a nozzle to spray steam generated in the flow passage by the steam generating heater.

15. The spray apparatus of claim 14, wherein the flow passage forming unit is directly connected to a water source.

16. The spray apparatus of claim 15 further comprising:
a valve between the water source and the inlet of the flow passage forming unit to control the water supply; and
a filter between the water source and the inlet of the flow passage forming unit to remove foreign substances in the supplied water.

17. The spray apparatus of claim 14, where the flow passage forming unit is connected to a water receiving unit via a water supply pipe.

18. The spray apparatus of claim 17, further comprising:
a pump to forcibly transfer water from the water receiving unit to the flow passage forming unit.

19. The spray apparatus of claim 17, wherein the water receiving unit is disposed within a removable drawer.

20. The spray apparatus of claim 14, wherein the flow passage forming unit and the nozzle are integrally formed.
